(19) United States
(12) Patent Application Publication
(10) Pub. No.: US 2013/0118277 A1
(43) Pub. Date: May 16, 2013

(54) DISPOSABLE ANIMAL FECAL SAMPLE KIT

(71) Applicant: Matthew Anthony Rodriguez, Detroit, MI (US)

(72) Inventor: Matthew Anthony Rodriguez, Detroit, MI (US)

(21) Appl. No.: 13/668,383

(22) Filed: Nov. 5, 2012

Related U.S. Application Data
(60) Provisional application No. 61/558,231, filed on Nov. 10, 2011.

(51) Int. Cl. A61D 99/00

(52) U.S. Cl. 73/864.91

(57) ABSTRACT

A disposable animal fecal sample kit including a fecal sample holding bag having a resealable closure adjacent an opening at one end thereof, and a hollow fecal sample collector tool to be stored within the fecal sample holding bag. The collector tool can have a notch formed at one end. An envelope can have indicia defining an animal fecal sample identification data entry location printed thereon and a sealable flap at one end. The envelope for receiving the fecal sample holding bag and hollow fecal sample collector tool therein. A fecal sample removal tool is engageable within the hollow fecal sample collector tool for pushing a fecal sample out of the collector tool. The removal tool can have one end with an external periphery complementary with respect to a cylindrical cross-section of the fecal sample collector tool and an opposite end with an enlarged finger grip portion.

### CROSS-REFERENCE TO RELATED APPLICATIONS

This application claims the benefit of U.S. Provisional Patent Application Ser. No. 61/558,231 filed on Nov. 10, 2011, which is incorporated by reference herein in its entirety.

### FIELD OF THE INVENTION

The invention relates to a device adapted to handle fecal waste excreted from an animal, such as a small domesticated animal, in a sanitary manner to collect a relatively small portion of a larger mass of excrement material to be tested by a veterinarian.

### BACKGROUND

Various devices are known for collecting fecal samples. For example, see U.S. Pat. No. 4,420,353; U.S. Pat. No. 4,510,887; U.S. Pat. No. 4,645,743; U.S. Pat. No. 4,735,905; U.S. Pat. No. 4,982,615; U.S. Pat. No. 5,149,506; U.S. Pat. No. 5,167,377; U.S. Pat. No. 5,727,500; U.S. Pat. No. 5,730,147; U.S. Pat. No. 5,787,843; U.S. Pat. No. 5,971,452; U.S. Pat. No. 6,653,149; U.S. Pat. No. 6,883,462; U.S. Pat. No. 7,871,568; and U.S. Pat. Application Publication No. 2010/0137741. While each of these devices appears to be suitable for the intended purpose disclosed, the devices are typically mechanically and/or structurally complicated resulting in greater difficulty of use and higher cost to the end user than desired.

### SUMMARY

It would be desirable to provide a low cost, sanitary, disposable animal fecal sample collection kit for use by pet owners and animal husbandry personnel. According to the present invention, a product can be assembled to provide a low cost, sanitary, disposable animal fecal collection kit for use by pet owners and animal husbandry workers including a hollow sample collector member and a resealable bag for receiving the sample collector member. A resealable bag or sealable envelope can be used for display point of sale prior to use and for transportation to a veterinarian after use. The resealable bag can be transparent and/or made from a plastic material.

A hollow fecal sample collector tool can have one end notched to create a scoop. The hollow sample collector tool can be an elongated cylindrical shaped tool. The tool with or without sample can be stored in a resealable transparent fecal sample holding bag. The resealable transparent fecal sample holding bag is an appropriate size to minimize movement of the tool and fecal sample, so as to reduce destruction of the fecal sample.

A nontransparent sealable envelope can be provided to enclose the transparent bag after the fecal sample collector tool has been placed within the transparent bag, so as to maintain a further level of sanitation. The exterior of the nontransparent sealable envelope can include printed indicia to provide instructions to the user and/or to collect information regarding the animal contributing the fecal sample. The nontransparent sealable envelope can also provide a visual barrier, if temporary storage of the sample stored in a household refrigeration unit is required. The envelope can be printed with indicia for the purpose of collecting information about the pet or livestock contributing the fecal sample to be tested.

The cylindrical shape of the fecal sample collector tool with scoop allows for collection of loose fecal samples through a shoveling motion and placement of a thumb over an opposite end to create a vacuum, so that a loose fecal sample remains in the sample tool during transport to the resealable fecal sample holding bag. With a solid fecal sample, a simple coring motion and slight twist can be used to obtain a small sample core from a solid fecal mass. Then the fecal sample and collector tool can be placed in the resealable transparent plastic fecal sample holding bag for easy removal by a technician. A technician examining the fecal sample is provided with information regarding the pet or livestock contributing the fecal sample printed on the nontransparent sealable envelope package. The invention provides a low cost, sanitary, disposable animal fecal sample collection kit in a discreet, affordable, and informative product package.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a plan view of a disposable animal fecal sample kit including an envelope, which can have indicia printed thereon, a resealable plastic bag, and a hollow fecal sample collector tool;

FIG. 2 is a plan view of an opposite side of the envelope of FIG. 1, which can have additional indicia printed thereon;

FIG. 3 is a plan view of the self-sealing plastic bag enclosing the hollow fecal sample collection tool of FIG. 1;

FIG. 4 is a perspective view of the hollow fecal sample collector tool of FIG. 1; and

FIG. 5 is a perspective view of an optional fecal sample removal tool or push plunger to empty animal fecal sample content collected in the hollow fecal sample collector tool of FIG. 4.

### DETAILED DESCRIPTION

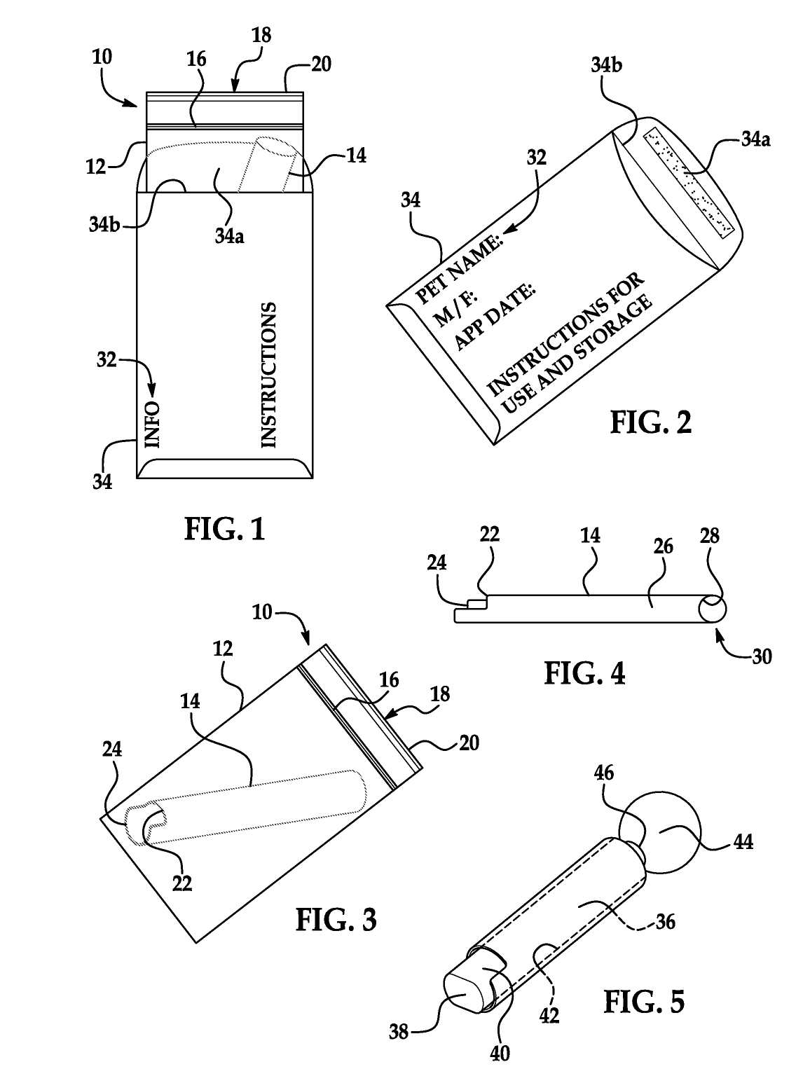

Referring now to FIGS. 1-4, a disposable animal fecal sample kit 10 can include a fecal sample holding bag 12, and a hollow fecal sample collector tool 14 to be stored within the fecal sample holding bag 12. By way of example and not limitation, the fecal sample holding bag 12 can be made of a transparent material, a plastic material, or a transparent plastic material. The fecal sample holding bag 12 can include a resealable closure 16 adjacent to an opening 18 at one end 20.

The hollow fecal sample collector tool 14 can include a notch 22 formed in one end 24 of the fecal sample collector tool 14 allowing collection of a loose fecal sample with a shoveling motion. The fecal sample collector tool 14 can be formed having an elongated cylindrical shape 26 with a longitudinally extending aperture 28 extending entirely therethrough to define a hollow interior 30. By way of example and not limitation, the fecal sample collector tool 14 can be made of a plastic material having a relatively thin wall thickness, similar to the construction of a plastic straw used for drinking beverages.

An animal fecal sample identification data entry location 32 can be associated with the fecal sample holding bag 12. By way of example and not limitation, the animal fecal sample identification data entry location can include information such as animal name, sex, and date/time sample was collected. The animal fecal sample identification data entry location 32 can be printed indicia located on a label to be attached to the fecal sample holding bag 12 or on an envelope 34 to receive the fecal sample holding bag 12 and fecal sample collector tool 14. The printed indicia can include additional information, by way of example and not limitation, such as instructions for use and storage of the animal fecal sample kit 10. The envelope 34 can be made of a nontransparent material, a paper material, or a nontransparent paper material. The envelope 34 can include a sealable flap 34a at one end 34b of the envelope 34.

An elongated fecal sample removal tool 36 can be engageable within the hollow fecal sample collector tool 14 for pushing a fecal sample out of the collector tool 14. The fecal sample removal tool 36 can have one end 38 with an external periphery 40 complementary with respect to an interior periphery 42 of the fecal sample collector tool 14. An enlarged finger grip portion 44 can be located at one end 46 of the fecal sample removal tool 36 to facilitate gripping and pushing to remove a fecal sample from the collector tool 14 for testing by a technician or veterinarian.

To collect a fecal sample, the animal fecal sample kit 10 can be used in several ways. To collect a loose fecal sample, the cylindrical shape of the fecal sample collector tool 14 with notch 22 defining a scoop allows for collection of loose fecal samples through a shoveling motion and placement of a thumb over an opposite end to create a vacuum, so that a loose fecal sample remains in the sample collector tool 14 during transport to the resealable fecal sample holding bag 12. Alternatively, the removal tool 36 can be pulled outward of the collector tool 14 to create a vacuum to collect extremely loose stools. With a solid fecal sample, a simple coring motion and slight twist can be used to obtain a small sample core from a solid fecal mass. Then the fecal sample and collector tool 14 can be placed in the resealable transparent plastic fecal sample holding bag 12 for easy removal by a technician. A technician examining the fecal sample is provided with information regarding the pet or livestock contributing the fecal sample printed on the nontransparent sealable envelope package. The technician or veterinarian can use the fecal sample removal tool 36 to push out the fecal sample contained within the hollow interior of the collector tool 14 for testing. The invention provides a low cost, sanitary, disposable animal fecal sample collection kit in a discreet, affordable, and informative product package that can be easily sold in animal clinics, veterinarian offices, and pet or livestock stores.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A disposable animal fecal sample kit comprising:
a fecal sample holding bag; and
a hollow fecal sample collector tool to be stored within the fecal sample holding bag.

2. The disposable animal fecal sample kit of claim 1, wherein the fecal sample holding bag is transparent.

3. The disposable animal fecal sample kit of claim 1, wherein the fecal sample holding bag is made of a plastic material.

4. The disposable animal fecal sample kit of claim 1 further comprising:
a resealable closure located adjacent to an opening at one end of the fecal sample holding bag.

5. The disposable animal fecal sample kit of claim 1 further comprising:
a notch formed in one end of the fecal sample collector tool allowing collection of a loose fecal sample with a shoveling motion.

6. The disposable animal fecal sample kit of claim 1, wherein the fecal sample collector tool has a cylindrical shape.

7. The disposable animal fecal sample kit of claim 1, wherein the fecal sample collector tool is made of plastic material.

8. The disposable animal fecal sample kit of claim 1 further comprising:
an animal fecal sample identification data entry location to be associated with the fecal sample holding bag.

9. The disposable animal fecal sample kit of claim 8 further comprising:
an envelope having printed indicia defining the animal fecal sample identification data entry location, the envelope for receiving the fecal sample holding bag and hollow fecal sample collector tool therein.

10. The disposable animal fecal sample kit of claim 9, wherein the envelope is nontransparent.

11. The disposable animal fecal sample kit of claim 9, wherein the envelope is made of paper material.

12. The disposable animal fecal sample kit of claim 9 further comprising:
a sealable flap on one end of the envelope.

13. The disposable animal fecal sample kit of claim 1 further comprising:
a fecal sample removal tool engageable within the hollow fecal sample collector tool for pushing a fecal sample out of the collector tool.

14. The disposable animal fecal sample kit of claim 13 further comprising:
the hollow fecal sample collection tool having an interior periphery; and
the fecal sample removal tool having at least one end with an external periphery complementary with respect to the interior periphery of the fecal sample collector tool.

15. The disposable animal fecal sample kit of claim 13 further comprising:
an enlarged finger grip portion located at one end of the fecal sample removal tool.

16. A disposable animal fecal sample kit comprising:
a fecal sample holding bag having a resealable closure adjacent an opening at one end thereof;
a hollow fecal sample collector tool to be stored within the fecal sample holding bag, the collector tool having a notch formed at one end; and
an envelope having indicia defining an animal fecal sample identification data entry location printed thereon and a sealable flap at one end, the envelope for receiving the fecal sample holding bag and hollow fecal sample collector tool therein.

17. The disposable animal fecal sample kit of claim 16 further comprising:
an elongated fecal sample removal tool engageable within the hollow fecal sample collector tool for pushing a fecal sample out of the collector tool, the removal tool having one end with an external periphery complementary with respect to an interior periphery of the collector tool, and an enlarged finger grip portion located at an opposite end.

18. The disposable animal fecal sample kit of claim 16, wherein the collector tool is made of a plastic material having an elongated cylindrical shape with a longitudinally extending aperture extending entirely therethrough to define a hollow interior.

19. The disposable animal fecal sample kit of claim 16, wherein the holding bag is made of a transparent, plastic material and the envelope is made of a nontransparent paper material.

20. A disposable animal fecal sample kit comprising:
a transparent plastic fecal sample holding bag having a resealable closure adjacent an opening at one end thereof;
a hollow, cylindrical, plastic, fecal sample collector tool to be stored within the fecal sample holding bag, the collector tool having a notch formed at one end;
a nontransparent paper envelope having printed indicia defining an animal fecal sample identification data entry location and a sealable flap at one end, the envelope for receiving the fecal sample holding bag and hollow fecal sample collector tool therein; and
a fecal sample removal tool engageable within the hollow fecal sample collector tool for pushing a fecal sample out of the collector tool, the removal tool having one end with an external periphery complementary with respect to a cylindrical cross-section of the fecal sample collector tool and an opposite end with an enlarged finger grip portion.
